(19) United States
(12) Patent Application Publication
(10) Pub. No.: US 2010/0289932 A1
(43) Pub. Date: Nov. 18, 2010

(54) SOLID-STATE IMAGING DEVICE

(75) Inventor: Masashi Hashimoto, Kyoto (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto (JP)

(21) Appl. No.: 12/096,728

(22) PCT Filed: Dec. 8, 2006
(86) PCT No.: PCT/JP2006/324562

§ 371 Date: Jun. 9, 2008

(30) Foreign Application Priority Data
Dec. 9, 2005 (JP) 2005-356557

(51) Int. Cl. H04N 5/335

(52) U.S. Cl. 348/300; 348/E05.091

(57) ABSTRACT

Suppressing increases in the area of an image cell while reducing fixed pattern noise (FPN). A photoelectric conversion signal is generated from photocurrent flowing through a photodiode (PD) in a pixel (Ca). A first transistor functioning as a load transistor is driven to operate in a strong inversion state and then operate in a subthreshold range. When the first transistor (T1) is operating in a subthreshold range, the potential at a sense node (N1) is read as a reset signal. Further, the difference between the photoelectric conversion signal and the reset signal is calculated to generate an image signal (Vs).

### FIELD OF THE INVENTION

The present invention relates to a solid state imaging device.

### BACKGROUND OF THE INVENTION

In the prior art, a MOS type imaging device is used to obtain various image data. Such an imaging device reads the charge accumulated in a pn junction capacitor of a photodiode through a MOS type transistor (e.g., field effect transistor (FET)).

Generally, the latitude, or dynamic range, of a MOS type imaging device is said to be narrower than that of a photographic negative film. If the latitude is narrow, dark parts of an image are recorded as black pixel data, and bright parts of an image are recoded as white pixel data.

A logarithm conversion type imaging device widens the dynamic range. As shown in FIG. 6, the imaging device includes an image cell formed by a photodiode PD, a load transistor T51, an amplification transistor T52, and a selection transistor T53. The cathode of the photodiode PD is connected to the source of the transistor T51, and the drain of the transistor T51 is connected to a signal line L1. The gate of the transistor T51 is supplied with gate voltage via a signal line so that the transistor T51 operates within a subthreshold range.

When light impinges on the pixel cell, photocurrent Ip flows through the photodiode PD in accordance with the light intensity. Due to the gate voltage, the transistor T51 operates in a weak inversion state. Thus, subthreshold current, which is substantially equal to the gate voltage, flows through the transistor T51. Accordingly, the potential at a node N51 stabilizes at a potential that is in accordance with the photocurrent Ip. A state in which the potential at the sense node N51 is stable is referred to as an electrically stable state (or electrically balanced state). The subthreshold current flowing through the transistor T51 is equal to the photocurrent Ip flowing through the photodiode PD. Therefore, the potential at the node N51 may be obtained through logarithm conversion. More specifically, the potential Vpox is obtained through the equation shown below (for details, refer to non-patent publication 1).

Vpxo=Vg−Vt_{—}1−nkT/q×ln(Ip/Ip0) (1)

The node N51 is connected to the gate of the amplification transistor T52. The amplification transistor T52 amplifies current with the potential Vpxo at the node N51 and outputs the amplified current to a signal line H1 via the selection transistor T53. The signal line H1 is connected to a current source (not shown). Due to the current source, the amplification transistor T52 operates as a source follower. When the current value of the current source is expressed by I_s and the transconductance and threshold of the transistor T52 are respectively expressed by β2 and Vt_2, the potential Vo at the signal line H1 is obtained from equation (2), which is shown below.

$$\begin{matrix}Vo = Vpso - Vt\_ 2 SQR ( 2 I\_s / β2 ) \\ = Vg - Vt\_ 1 - nkT / q \times ln ( IP / Ip 0 ) - \\ Vt\_ 2 - SQR ( 2 I\_s / β2 ) \\ = Vg - nkT / q \times ln ( IP / Ip 0 ) - \\ \{ Vt\_ 1 + Vt\_ 2 + SQR ( 2 I\_s / β2 ) \}\end{matrix} \qquad ( 2 )$$

In equation (2), the value of the term in the large brackets { } at the right side is changed by threshold variations and transconductance variations of the load transistor T51 and the amplification transistor T52 that result from manufacturing processes. Such changes varies the potential Vo at the signal line H1, or the value of a pixel signal, and variations in the value of the pixel signal generates image signal noise. The noise appears at a fixed position in an image and is thus referred to as a fixed pattern noise (hereafter, referred to as FPN).

To reduce the FPN, image cells of various structures have been proposed for a logarithm conversion type imaging device. For example, in non-patent publication 1, a single image cell is formed by a single photodiode, six MOSFETs, and a single capacitor. Further, in non-patent publication 2, a single image cell is formed by a single photodiode and five MOSFETs.

The FPN is a problem that must also be coped with in devices other than a logarithm conversion type imaging device. Such imaging devices each include a capacitor for accumulating charge from photodiode current that is generated by a photoelectric conversion element, such as a photodiode. The charge amount of the capacitor changes in accordance with the accumulation time. In other words, these imaging devices read the charge amount of the capacitor until the accumulation of charge in the capacitor ends, that is, reads the charge amount in a transitional state.

Non-Patent Publication 1: “Development of Logarithm Conversion Type CMOS Image Sensor,” KONICA MINOLTA TECHNOLOGY REPORT, volume 1, 2004, pp. 45-50
Non-Patent Publication 2: “A Logarithm Response CMOS Image Sensor with On-Chip Calibration,” IEEE Journal of Solid state Circuits, August, 2000, volume 35, pp. 1146-1152

In an imaging device that generates a pixel signal in a transitional state as described above, the FPN is reduced by using a circuit for correlated double sampling (CDS) or the like. However, referring to FIG. 6, in a logarithm conversion type imaging device that generates a pixel signal in accordance with the potential at the node N51 in an electrically balanced state, a circuit for correlated double sampling (CDS) or the like used in an imaging device for generating a pixel signal in the above-described transitional state cannot be directly applied. This is because of the difference in the control for generating a signal from each pixel. Although logarithm conversion is performed, the technologies described in non-patent publication 1 and non-patent publication 2 generate a pixel signal with the charge accumulated in a capacitor and thus operate in the same manner as an imaging device that generates a signal in the above-described transitional state.

Furthermore, in the technologies described in non-patent publication 1 and non-patent publication 2, a single pixel is formed by many elements. This reduces the so-called aperture ratio, which is the ratio of the area occupied by a photodiode in a single pixel. Further, since the area for each pixel increases, the chip size increases. This increases the chip deficiency rate and lowers production efficiency.

To minimize leak current through the node N51, which is for detecting the photocurrent Ip, the addition of elements is not preferable. However, in the technologies described in non-patent publication 1 and non-patent publication 2, the addition of elements is inevitable for the structure shown in FIG. 6. This increases the leak current, or dark current, caused by the added elements.

### SUMMARY OF THE INVENTION

The present invention provides a solid state imaging device that reduces fixed pattern noise while preventing increases in the area of an image cell.

A first aspect of the present invention provides a solid state imaging device. The solid state imaging device is provided with a pixel including a light reception element which performs photoelectric conversion on incident light. A load transistor receives a first drive signal and operates in response to a second drive signal. A switch transistor is connected between the load transistor and the light reception element. A sense node is arranged between the load transistor and the switch transistor. An amplification transistor has a control terminal connected to the sense node. A selection transistor is connected to the amplification transistor. A control means drives the pixel during at least a photoelectric conversion period, a data read period, and a reset period. The control means operates the load transistor in a subthreshold range in accordance with the first drive signal and the second drive signal during the photoelectric conversion period to perform photoelectric conversion on the incident light with the light reception element, activates the selection transistor during the data read period to read a potential at the sense node as a photoelectric conversion signal, and further operates the load transistor in the subthreshold range after deactivating the switch transistor and activating the load transistor during the reset period to activate the selection transistor when the load transistor is operating and read the potential at the sense node as a reset signal. A correlated double sampling circuit obtains the photoelectric conversion signal and the reset signal to subtract the reset signal from the photoelectric conversion signal.

In this invention, when the intensity of incident light is high, the photocurrent flowing through the light reception element undergoes logarithm conversion, and the potential at the sense node is read as the photoelectric conversion signal. The photoelectric conversion signal includes fixed pattern noise. The reset signal includes the threshold voltage of the load transistor and amplification transistor and the transconductance of the amplification transistor that cause fixed pattern noise. Accordingly, generation of the difference between the photoelectric conversion signal and the reset signal obtains an image signal that does not include fixed pattern noise. Further, by forming a pixel with a single light reception element and four transistors, the ratio of the area occupied by a photodiode in a single pixel, or the aperture ratio, may be increased. Further, since an increase in the area of each pixel is suppressed, enlargement of the chip size is prevented, the chip deficiency rate is kept low, and the productivity rate is prevented from decreasing.

A second aspect of the present invention provides a solid state imaging device. The solid state imaging device is provided with a pixel including a light reception element which performs photoelectric conversion on incident light. A load transistor receives a first drive signal and operates in response to a second drive signal. A switch transistor is connected between the load transistor and the light reception element. A sense node is arranged between the load transistor and the switch transistor. An amplification transistor has a control terminal connected to the sense node. A selection transistor is connected to the amplification transistor. A control means drives the pixel during at least a photoelectric conversion period, a data read period, and a reset period. The control means operates the load transistor in a subthreshold range in accordance with the first drive signal and the second drive signal during the photoelectric conversion period to perform photoelectric conversion on the incident light with the light reception element, activates the selection transistor during the data read period to read a potential at the sense node as a photoelectric conversion signal, and further deactivates the switch transistor, activates the load transistor, and activates the selection transistor during the reset period to read the potential at the sense node as a reset signal. A correlated double sampling circuit obtains the photoelectric conversion signal and the reset signal to subtract the reset signal from the photoelectric conversion signal.

In this invention, when the intensity of incident light is low, the photocurrent flowing through the light reception element undergoes linear conversion, and the potential at the sense node is read as the photoelectric conversion signal. The photoelectric conversion signal includes fixed pattern noise. The reset signal includes the threshold voltage of the load transistor and amplification transistor and the transconductance of the amplification transistor that cause fixed pattern noise. Accordingly, generation of the difference between the photoelectric conversion signal and the reset signal obtains an image signal that does not include fixed pattern noise. Further, by forming a pixel with a single light reception element and four transistors, the ratio of the area occupied by a photodiode in a single pixel, or the aperture ratio, may be increased. Further, since an increase in the area of each pixel is suppressed, enlargement of the chip size is prevented, the chip deficiency rate is kept low, and the productivity rate is prevented from decreasing.

A third embodiment of the present invention provides a solid state imaging device. The solid state imaging device is provided with a pixel including a light reception element which performs photoelectric conversion on incident light. A load transistor receives a first drive signal and operates in response to a second drive signal. A switch transistor is connected between the load transistor and the light reception element. A sense node being is arranged between the load transistor and the switch transistor. An amplification transistor has a control terminal connected to the sense node. A selection transistor is connected to the amplification transistor. A control means drives the pixel during at least a photoelectric conversion period, a data read period, and a reset period. The control means operates the load transistor in a subthreshold range in accordance with the first drive signal and the second drive signal during the photoelectric conversion period to perform photoelectric conversion on the incident light with the light reception element, activates the selection transistor during the data read period to read a potential at the sense node as a photoelectric conversion signal, and further operates the load transistor in the subthreshold range after deactivating the switch transistor and activating the load transistor during the reset period to activate the selection transistor when the load transistor is operating and read the potential at the sense node as a first reset signal and read the potential at the sense node when the load transistor is activated as a second reset signal. A correlated double sampling circuit obtains the photoelectric conversion signal, the first reset signal, and the second reset signal to generate an image signal based on a first difference between the photoelectric conversion signal and the first reset signal and a second difference between the first reset signal and the second reset signal.

In this invention, the photocurrent flowing through the light reception element is converted, and the potential at the sense node is read as a photoelectric conversion signal. The photoelectric conversion signal includes fixed pattern noise. The first reset signal includes the threshold voltage of the load transistor and amplification transistor and the transconductance of the amplification transistor that cause fixed pattern noise. The second reset signal includes the threshold voltage and transconductance of the amplification transistor. Accordingly, when the intensity of incident light is high in the light reception element, photocurrent undergoes logarithm conversion. Thus, the generation of the difference between the photoelectric conversion signal, which has undergone logarithm conversion, and the first reset signal obtains an image signal that does not include fixed pattern noise. When the intensity of intensity light is low in the light reception element, photocurrent undergoes linear conversion. In this case, the difference between the photoelectric conversion signal and the first reset signal does not include the threshold voltage of the first transistor. The difference between the first reset signal and the second reset signal is obtained to obtain the threshold voltage of the first transistor. Therefore, by adding the difference between the first reset signal and the second reset signal to the difference between the photoelectric conversion signal and the first reset signal, fixed pattern noise is eliminated from an image signal when the intensity of incident light is low. Further, by forming a pixel with a single light reception element and four transistors, the ratio of the area occupied by a photodiode in a single pixel, or the aperture ratio, may be increased. Further, since an increase in the area of each pixel is suppressed, enlargement of the chip size is prevented, the chip deficiency rate is kept low, and the productivity rate is prevented from decreasing.

The correlated double sampling circuit includes a first sample hold circuit which holds the photoelectric conversion signal. A second sample hold circuit holds the first reset signal. A third sample hold circuit holds the second reset signal. A first difference generation circuit calculates the first difference between the photoelectric conversion signal held by the first sample hold circuit and the first reset signal held by the second sample hold circuit to generate a first output signal. A second difference generation circuit calculates the second difference between the first reset signal held by the second sample hold circuit and the second reset signal held by the third sample hold circuit to generate a second output signal. An adder circuit which the first output signal of the first difference generation circuit and the second output signal of the second difference generation circuit to generate a sum signal. A comparison circuit compares the first output signal of the first difference generation circuit with a reference voltage to generate a selection signal. A selection circuit selects as the image signal either one of the first output signal of the first difference generation circuit and the sum signal of the adder circuit based on the selection signal of the comparison circuit.

By comparing the output signal of the first difference generation circuit with the reference voltage, the intensity of the incident light in the light reception element can be determined. Thus, by selecting as the image signal either one of the first output signal of the first difference generation circuit and the second output signal of the adder circuit, an image signal from which fixed pattern noise is eliminated may be obtained regardless of the intensity of the incident light.

As described above, the present invention reduces fixed pattern noise and prevents the area of the image cell from increasing.

### BRIEF DESCRIPTION OF THE DRAWINGS

FIG. 1A is a schematic block circuit diagram showing the main part of a solid state imaging device according to a first embodiment of the present invention;

FIG. 1B is a drive waveform chart of a pixel in FIG. 1A;

FIG. 2 is a schematic block circuit diagram of the solid state imaging device according to the first embodiment of the present invention;

FIG. 3 is a drive waveform chart of a pixel in a second embodiment of the present invention;

FIG. 4 is a schematic block circuit diagram showing the main part of a solid state imaging device according to a third embodiment of the present invention;

FIG. 5 is a drive waveform chart of a pixel in a third embodiment of the present invention; and

FIG. 6 is a circuit diagram of a pixel in the prior art.

### DETAILED DESCRIPTION OF THE PREFERRED EMBODIMENTS

A solid state imaging device 10 according to a first embodiment of the present invention will now be discussed with reference to the drawings.

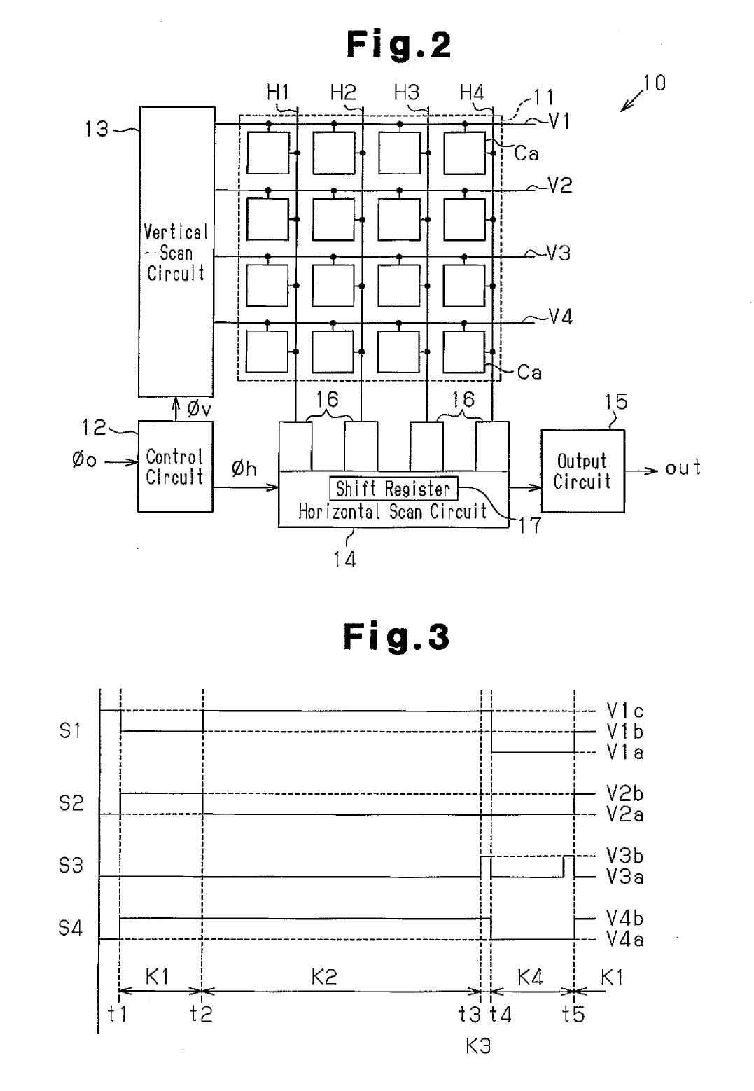

FIG. 2 is a schematic block circuit diagram of the solid state imaging device 10.

The solid state imaging device 10 includes an imaging unit 11, a control circuit 12, a vertical scan circuit 13, a horizontal scan circuit 14, and an output circuit 15.

The imaging unit 11 includes a plurality of pixels Ca arranged in a matrix. For the sake of brevity, the first embodiment will be discussed with the imaging unit 11 including 16 pixels Ca that are arranged in a matrix of four columns and four rows.

Based on a clock signal Φ0, the control circuit 12 generates a vertical clock signal Φv, which serves as a selection signal for selecting a row in the imaging unit 11, a horizontal clock signal Φh, which serves as a selection signal for selecting a column in the imaging unit 11, and a control signal for controlling and driving the pixels Ca and the like.

The vertical scan circuit 13 includes a vertical direction shift register and a voltage control circuit, which controls the voltage supplied to each of the pixels Ca. Further, the vertical scan circuit 13 is connected to four row signal lines V1 to V4, one for each row in the imaging unit 11. The vertical scan circuit 13 sequentially selects the row signal lines V1 to V4 in response to the vertical clock signal Φv and supplies the pixels Ca (four in FIG. 2) connected to the selected row signal line with voltage controlled by the voltage control circuit.

The horizontal scan circuit 14 includes four correlated double sampling circuits (hereafter, referred to as the CDS circuits) 16, one for each column in the imaging unit 11, and a shift register 17. The pixels Ca are connected at intersections of the row signal lines V1 to V4 and the column signal lines H1 to H4.

In response to a drive signal provided by a corresponding one of the row signal lines V1 to V4, each pixel Ca outputs a photoelectric conversion signal and a reset signal to a corresponding one of the column signal lines H1 to H4. The CDS circuits 16 connected to the column signal lines H1 to H4 samples the photoelectric conversion signal and reset signal provided by a corresponding one of the column signal lines H1 to H4 and generates a signal that is in accordance with the difference between the two sampled signals. The shift register 18 transfers the signal provided from each CDS circuit 16 to the output circuit 15 in accordance with the horizontal clock signal Φh.

The output circuit 15 expands the pulse width of the signal provided from the horizontal scan circuit 14 and generates an output signal out, which indicates the expansion result.

Next, the structures of the pixels Ca will be discussed. Since each pixel Ca has the same structure, description will be given on the pixel Ca connected to the row selection line V1 and the column signal line H1.

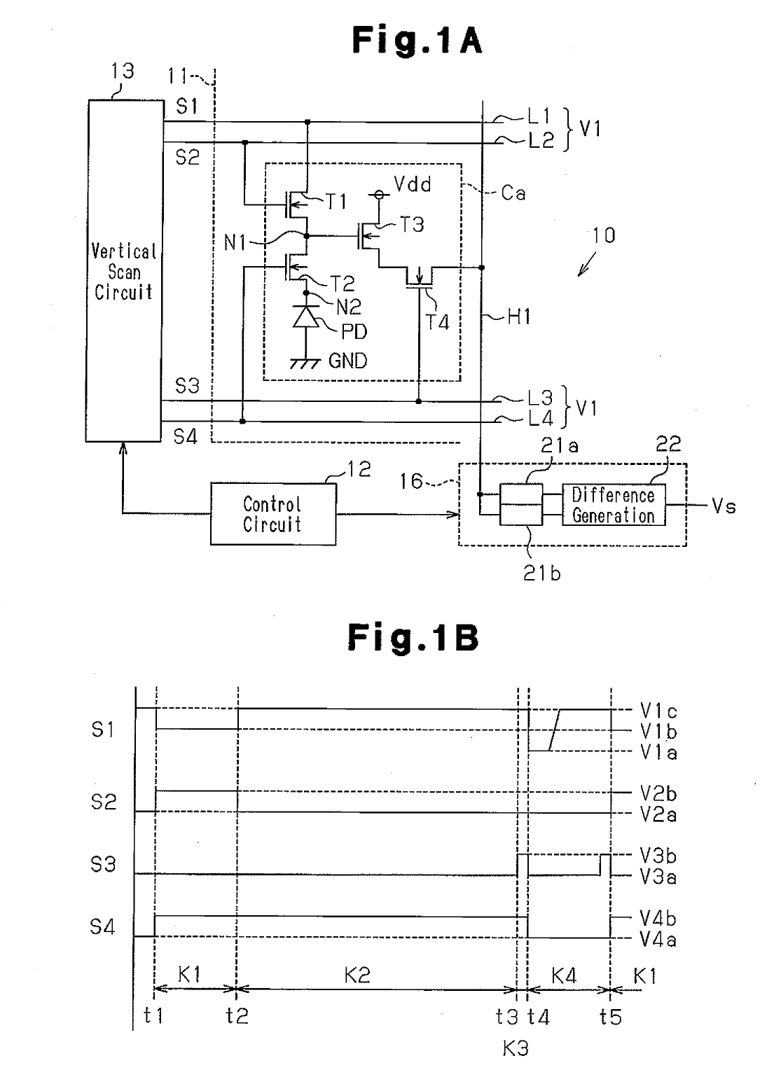

As shown in FIG. 1A, the pixel Ca is formed by a photodiode PD, which serves as a light reception element, and four transistors T1, T2, T3, and T4. The first to fourth transistors T1, T2, T3, and T4 are transistors of the same conduction channel type (in the first embodiment, N-channel type transistors). Although not shown in the drawings, the transistors T1 to T4 each have a back gate connected to ground GND. Further, the row selection line V1 is formed by four signal lines L1 to L4, and the pixel Ca is provided with drive signals S1 to S4 from the vertical scan circuit 13 via the signal lines L1 to L4.

The first transistor T1, which serves as a load transistor, has a drain (first terminal) connected to the first signal line L1, a gate (second terminal) connected to the second signal line L2, and a source connected to the drain of the second transistor T2, which serves as a switch transistor. Accordingly, in the first transistor T1, the drain is provided with the first drive signal S1 and the gate is provided with the second drive signal S2. Thus, the first transistor T1 operates in accordance with the first drive signal S1 and second drive signal S2.

The gate of the second transistor T2 is connected to the fourth signal line L4. Accordingly, the second transistor T2 operates in accordance with the fourth drive signal S4. The source of the second transistor T2 is connected to the cathode of the photodiode PD. The node of the photodiode PD is connected to a low potential power supply (in the first embodiment, ground GND).

A sense node N1, which is a connection point between the first transistor T1 and the second transistor T2, is connected to the gate of the third transistor T3, which serves as an amplification transistor. The third transistor T3 includes a drain supplied with drive voltage Vdd and a source connected to the drain of the fourth transistor T4, which serves as a pixel selection transistor. The fourth transistor T4 includes a gate connected to the third signal line L3 and a source connected to the column signal line H1. Accordingly, the fourth transistor T4 operates in accordance with the third drive signal S3.

The column signal line H1 is connected to the CDS circuit 16. The CDS circuit 16 is formed by two sample hold circuits (hereafter, referred to as SH circuits) 21a and 21b and a difference generation circuit 22. The SH circuits 21a and 21b hold signals transmitted via the column signal line H1 in response to a control signal provided from the control circuit 12. The first SH circuit 21a holds a photoelectric conversion signal provided from the pixel Ca, and the second SH circuit 21b holds a reset signal provided from the pixel Ca. The difference generation circuit 22 obtains the difference between the photoelectric conversion signal and reset signal held by the two SH circuits 21a and 21b to generate a signal indicating the difference.

The pixel CA, which is formed as described above, operates in accordance with the potentials at the row signal lines L1 to L4, that is, the voltages of the drive signals S1 to S4. In response to a control signal from the control circuit 12, the vertical scan circuit 13 varies the voltages of the drive signals S1 to S4 as shown in FIG. 1B.

Initially, during a first reset period K1 from time t1 to time t2, the drain of the first transistor T1 is provided with the first drive signal S1 having voltage V1b via the first signal line L1. The gate of the first transistor T1 is provided with the second drive signal S2 having voltage V2b via the second signal line L2. The gate of the second transistor T2 is provided with the fourth drive signal S4 having voltage V4b via the fourth signal line L4. The gate of the fourth transistor T4 is provided with the third drive signal S3 having voltage V3a via the third signal line L3.

The voltage V1b of the first drive signal S1 and the voltage V2b of the second drive signal S2 are set to, for example, V1b=2.5[V] and V2b=4[V] so that the first transistor T1 operates in a strong inversion state, that is, so that the first transistor T1 is activated. To activate the second transistor T2, the voltage V4b of the fourth drive signal S4 is set to, for example, V4b=4[V]. To deactivate the fourth transistor T4, the voltage Via of the third drive signal S3 is set to, for example, V3a=0[V].

Accordingly, the potentials at the sense node N1 and a node N2, which is located between the second transistor T2 and the photodiode PD, indicates voltage V1b (V1b=2.5[V]), which is substantially the same as the first drive signal S1. This initializes the output potential. The initialization prevents light that has entered the photodiode PD in the past, or a residual image, from affecting the next photoelectric conversion signal.

Next, during a photoelectric conversion period K2 from time t2 to time t3, photoelectric conversion of image information is performed. More specifically, during the photoelectric conversion period K2, the drain of the first transistor T1 is provided with the first drive signal S1 having voltage V1c via the first signal line L1. The gate of the first transistor T1 is provided with the second drive signal S2 having voltage V2a via the second signal line L2. The voltage V1c of the first drive signal S1 and the voltage V2a of the second drive signal S2 are set, for example, to V1c=3.3[V] and V2a=3.3[V] so that the first transistor T1 operates in a weak inversion state, or the so-called subthreshold range.

In the same manner as in the first reset period K1, the second transistor T2 is activated by the fourth drive signal S4 having voltage V4b. Further, in the same manner as in the first reset period K1, the fourth transistor T4 is deactivated by the third drive signal S3 having voltage V3a. Accordingly, the potentials at the sense node N1 and node N2 are substantially the same.

When a bright image is generated, that is, when the intensity of the incident light is high, the potential Vpxo at the sense node N1 id determined as described below.

A relatively large photocurrent Ip flows through the photodiode when a bright image is generated, that is, when the intensity of the incident light is high. The potential Vpxo at the sense node N1 is in accordance with the photocurrent Ip, and the time for the potential to stabilize and shift to a normal state is shorter than the predetermined photoelectric conversion period K2. In other words, the potential at the sense node N1 shifts to a normal state before the next data read period K3 starts. The second transistor T2 between the sense node N1 and photodiode PD operates in a strong inversion state and may thus simply be considered as an activated switch. Accordingly, the potential Vpxo at the sense node N1 is determined so as to satisfy the relationship of equation (1). Thus, the potential Vpxo at the sense node N1 is expressed by a logarithm conversion of photocurrent.

Subsequently, during the data read period K3 from time t3 to time t4, the gate of the fourth transistor T4 is provided with the third drive signal S3 having voltage V3b via the third signal line L3. The voltage V3b is set, for example, to V3b=3.3[V] so that the fourth transistor T4 is activated. Accordingly, the source of the third transistor T3 is connected to the column signal line H1 via the activated fourth transistor T4. The column signal line H1 is connected to a current source, which is not shown. Due to the current source, the third transistor T3 operates as a source follower. Accordingly, the potential at the column signal line J1 is in accordance with the gate voltage of the third transistor T3, or the potential at the sense node N1. That is, the photocurrent Ip is read onto the column signal line H1 as a photoelectric conversion signal. The photoelectric signal Vo is expressed by the above equation (2).

Then, in a second reset period K4 from time t4 to time t5, the threshold voltage Vt_1 of the first transistor T1 and the threshold voltage Vt_2 and transconductance β2 of the third transistor T3 are detected. The detected values are used in a process for correcting variations resulting from manufacturing processes.

More specifically, in the second reset period K4, first, the drain of the first transistor T1 is provided with the first drive signal S1 having voltage V1a via the first signal line L1, and the gate of the first transistor T1 is provided with the second drive signal S2 having voltage V2a via the second signal line L2. Further, the gate of the second transistor T2 is provided with the fourth drive signal S4 having voltage V4a via the fourth signal line L4, and the gate of the fourth transistor T4 is provided with the third drive signal S3 having voltage V3a via the third signal line L3.

The voltage V1a of the first drive signal S1 and the voltage V2b of the second drive signal S2 are set to, for example, V1a=2[V] (V2a=3.3[V]) so that the first transistor T1 operates in a strong inversion state, that is, so that the first transistor T1 is activated. To deactivate the second transistor T2, the voltage V4b of the fourth drive signal S4 is set to, for example, V4a=0[V].

Accordingly, the second transistor 2 breaks the current path from the first transistor T1 to the photodiode PD. As a result, the potential at the sense node N1 becomes substantially the same as the voltage Via of the first drive signal S1.

Next, the voltage of the first drive signal S1 provided to the drain of the first transistor T1 is increased from voltage V1a to voltage V1c. In this state, the gate of the first transistor T1 is provided with the second drive signal S2 having voltage V2a. Thus, the first transistor T1 operates in the subthreshold range. As a result, the potential at the sense node N1 decreases from the voltage V2a of the second drive signal S2 provided to the gate of the first transistor T1 by an amount corresponding to the threshold voltage Vt_1 of the transistor T1. That is, the potential Vpx_comp at the sense node in this state is the difference between the gate voltage V2a of the first transistor T1 and the threshold voltage Vt_1 of the transistor T1 and expressed as shown below.

Vpx_comp=V2a−Vt_{—}1 (3)

Then, the voltage of the third drive signal S3 provided to the gate of the fourth transistor T4 is increased from voltage V3a to voltage V3b. The third drive signal S3 having voltage V3a activates the fourth transistor T4, and the potential at the sense node N1 is read onto the column signal line H1 as a reset signal Vo_comp.

The reset signal Vo_comp in this state is expressed as described below.

$$\begin{matrix}Vo\_comp = Vpx\_comp - Vt\_ 2 - SQR ( 2 I\_s / β2 ) \\ = V 2 a - \{ Vt\_ 1 + Vt\_ 2 + SQR ( 2 I\_s / β 2 ) \}\end{matrix} \qquad ( 4 )$$

In other words, the reset signal Vo_comp is expressed by the difference between the gate voltage V2a of the first transistor T1 and the voltage component of {Vt_1+Vt_2+SQR(2I_s/β2)}, which causes FPN.

In the CDS circuit 16 shown in FIG. 1A, the first SH circuit 21a holds the photoelectric conversion signal Vo, and the second SH circuit 21b holds the reset signal Vo_comp. The difference generation circuit 22 calculates the difference between the photoelectric conversion signal Vo of the first SH circuit 21a and the reset signal Vo_comp of the second SH circuit 21b. Further, the difference generation circuit 22 adds a preset voltage V2a to the calculation result. Consequently, the difference generation circuit 22 generates an image signal Vs by subtracting the voltage component causing FPN from the photoelectric conversion signal Vo. The image signal Vs is generated as image information from which FPN is eliminated.

The solid state imaging device 10 of the first embodiment has the advantages described below.

In the first embodiment, with respect to the photoelectric conversion signal obtained by performing logarithm conversion on the photocurrent Ip in the pixel Ca, the first transistor T1, which functions as a load transistor, is driven to operate in a subthreshold range after operating in a strong inversion state. The potential at the sense node N1 in this state is read as a reset signal. Accordingly, in an imaging device that generates a signal in accordance with the potential at the sense node N1 in an electrically balanced state, the reset signal subsequent to the resetting of a pixel is read. Further, the image signal Vs is generated from the difference between a photoelectric conversion signal and a reset signal. Accordingly, fixed pattern noise (FPN) is eliminated from the image signal Vs even when the intensity of the incident light in the photodiode PD is high.

In the first embodiment, the second transistor T2, which functions as a switch transistor, is connected in series between the first transistor T1, which functions as a load transistor, and a photodiode PD, which functions as a light reception element, in a pixel Ca. The second transistor T2 is deactivated during the second reset period. Further, a reset signal is read from the pixel Ca during the second reset period to eliminate FPN. Accordingly, since the pixel Ca is formed by the single photodiode PD and the four transistors T1 to T4, the so-called aperture ratio, which is the ratio of the area occupied by a photodiode in a single pixel, may be increased. Further, an increase in the area of each pixel can be suppressed. This prevents enlargement of the chip size. Further, the chip deficiency rate and the production efficiency are prevented from being decreased.

A single pixel Ca is formed by a single photodiode PD and four transistors T1 to T4. Thus, the number of additional elements is small. This prevents an increase in leak current, or dark current, which would be caused by additional elements.

A second embodiment of the present invention will now be discussed with reference to the drawings.

The second embodiment differs from the first embodiment in drive waveform of a pixel so that the pixel ca is properly driven when generating a dark image.

The vertical scan circuit 13 shown in FIG. 1A varies the drive signals as shown in FIG. 3 in response to a control signal from the control circuit 12.

During a photoelectric conversion period K2 from time t2 to time t3, the vertical scan circuit 13 provides the drive signals S1 to S4 to the signal lines L1 to L4 in the same manner as in the first embodiment. The potential at the sense node N1 when a dark image is generated, or when the intensity of the incident light is low, is determined as described below.

When a dark image is generated, or when the intensity of the incident light is low, the photocurrent Ip flowing through the photodiode PD is small. Thus, the potential at the sense node N1 does not shift to the normal state during the predetermined photoelectric conversion period K2. In a transitional state in which the photocurrent Ip is varying during the photoelectric conversion period K2, the potential at the sense node N1 varies between values approximated to a substantially straight line. In other words, the photocurrent Ip is linearly varied.

In detail, at the same time as when the photoelectric conversion period K2 starts, due to the first drive signal S1 having voltage V1c and the second drive signal S2 having voltage V2a, the first transistor T1 enters the subthreshold range. The potential at the sense node N1 just before the photoelectric conversion period J2, or during the first reset period J1, is voltage V1b (V1b=2.5[V]), which is set by the first drive signal S1. Thus, the current I_M1 that flows through the first transistor T1 is expressed as shown below.

$$\begin{matrix}I\_M1 = A * exp [ 1 / nkt ( Vg - Vs - Vt\_ 1 ) ] \\ = A * exp \{ q / nkt ( V 1 c - V 1 b - Vt\_ 1 ) \}\end{matrix} \qquad ( 5 )$$

Photocurrent Ip, which is in accordance with the incident light, flows through the photodiode. However, the photocurrent Ip and the current I_M1 flowing through the first transistor T1 have a relationship represented by the expression shown below.

Ip>>I_{—M}1 (6)

Thus, the potential at the sense node N1 decreases until the photocurrent Ip and the current I_M1 flowing through the first transistor T1 become equal (Ip=I_M1). As shown by equation (5), the current I_M1 varies in the manner of a logarithm with respect to changes in the potential at the sense node N1 (the Vs term in equation (5)). Accordingly, the relationship of expression (6) may be satisfied until just before Ip=I_M1 is satisfied. In such a non-normal state before Ip=I_M1 is satisfied, electric balance is obtained by the charge accumulated in a parasitic capacitor existing at the sense node N1 and node N2. When the effective parasitic capacitor at the sense node N1 and node. N2 is expressed by Cp, the equation shown below is obtained.

Q(t=0)=Cv=Cp×V1b (7)

Charge Q, which is obtained from the above equation, is accumulated in the capacitor Cp just before the photoelectric conversion period K2 starts. The second transistor T2 functions as a low-resistance switch in a normal state and functions as a capacitor element that forms the capacitor Cp in a non-normal state, or in an AC manner.

When entering the photoelectric conversion period K2, the potential at the sense node N1 shifts to a non-normal state, and the charge Q accumulated in the capacitor Cp flows as the difference between the photocurrent Ip and the current I_M1 of the first transistor T1 to the ground GND via the photodiode PD but does not flow via the first transistor T1. The charge that flows is expressed as shown below.

Ip−I_{—}M1=dQ/dt=Cp×dV/dt (8)

The relationship of expression (6) is satisfied until just before Ip=I_M1 is satisfied. Thus, the left side Ip−I_M1 is approximated with Ip. Ip is constant current. Thus, the right side dV/dt is also constant. Accordingly, the potential at the sense node varies linearly.

Next, during the data read period K3 from time t3 to time t4, in the same manner as in the first embodiment, the fourth transistor T4 is activated, and the potential at the sense node N1 is linearly varied. Thus, voltage that is linearly converted from the photocurrent Ip is read to the column signal line H1.

In the case of a linear conversion, the current supplied from the first transistor T1 has a smaller value than the photocurrent and can be ignored. Thus, if the time during which the photoelectric conversion period K2 starts and ends is t_a(t_a=t3−t4), the potential Vpxo(t_a) at the sense node N1 can be derived from expression (6) and be expressed as shown below.

Vo(t_{—}a)=(Ip/Cp)×ta−Vt_{—}2−SQR(2I_{—}s/β2) (10)

The photoelectric conversion signal Vo(t_a) does not include the term of the threshold voltage Vt_1 for the first transistor T1. Accordingly, the voltage Vo(t_a) is not dependent on the threshold voltage Vt_1 of the first transistor T1.

In the first embodiment, to obtain the reset signal, during the second reset period K4, the first drive signal S1 is once lowered to the voltage V1a (=2.0[V]) and then raised to the voltage V1c (=3.3[V]). In this state, as long as the first drive signal S1 is held at the voltage V1a (=2.0[V]), the potential at the sense node N1 does not vary. That is, the threshold voltage Vt_1 of the first transistor T1 is not related with the reset signal. Accordingly, in the second embodiment, during the second reset period K4, the first drive signal S1 is sustained at the voltage V1a. This expresses the reset signal Vo_comp2 read during the second reset period K4 as shown below.

Vo_{—}comp2=V1a−{Vt_{—}2+SQR(2I_{—}s/β2)} (11)

The photoelectric conversion signal Vo(t_a) of equation (10) and the reset signal Vo_comp2 of equation (11) are respectively held by the SH circuits 21a and 21b shown in FIG. 1A. Accordingly, in the same manner as in the first embodiment, by calculating the difference between the two signals with the difference generation circuit 22, correlated double sampling eliminates FPN. This obtains image information that does not include FPN.

The second embodiment has the advantage described below.

In the second embodiment, with regard to a photoelectric conversion signal obtained by linearly converting the photocurrent Ip in a pixel Ca, the potential at the sense node N1 is read as a reset signal when the first transistor T1, which functions as a load transistor, operates in a strong inversion state. Further, an image signal is generated from the difference between the photoelectric conversion signal and the reset signal. Accordingly, an image signal from which FPN is eliminated is obtained even when the intensity of the incident light is low in the photodiode PD.

A third embodiment of the present invention will now be discussed with reference to the drawings.

In the third embodiment, components that are the same as those in the first and second embodiment are denoted with the same reference numerals.

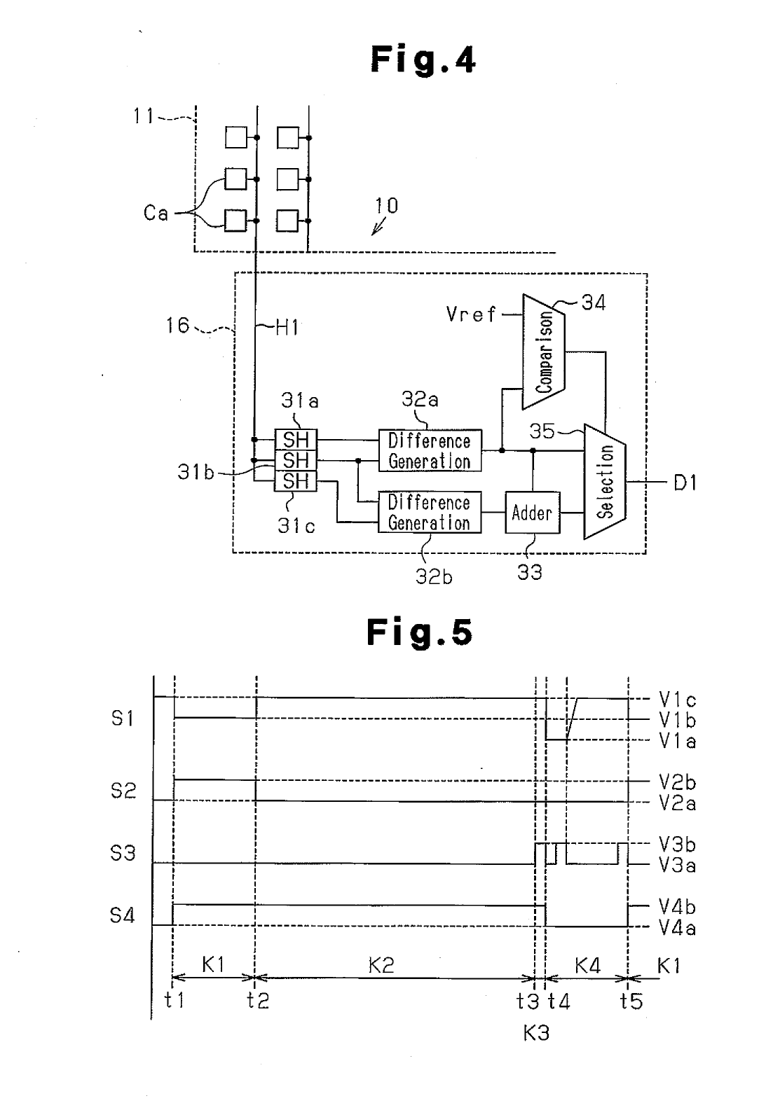

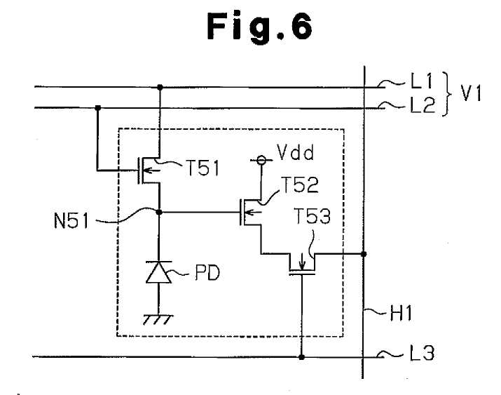

Referring to FIG. 4, the CDS circuit 16 of the third embodiment includes three SH circuits 31a, 31b, and 31c, two difference generation circuits 32a and 32b, an adder circuit 33, a comparison circuit 34, and a selection circuit 35.

The SH circuits 31a to 31c, which are connected to the column signal line H1, hold a signal of the column signal line H1. The signal held by the first SH circuit 31a is provided to the first differential generation circuit 32a. The signal held by the second SH circuit 31b is provided to the first difference generation circuit 32a and second difference generation circuit 32b. The signal held by the third SH circuit 31c is provided to the second differential generation circuit 32b.

The first difference generation circuit 32a obtains the difference between the two signals held by the first SH circuit 31a and the second SH circuit 31b to generate a signal indicating the difference. The second difference generation circuit 32b obtains the difference between the two signals held by the second SH circuit 31b and the third SH circuit 31c to generate a signal indicating the difference.

The adder circuit 33 adds the output signal of the first difference generation circuit 32a and the output signal of the second difference generation circuit 32b to generate a signal indicating the sum. The comparison circuit 34 compares the output signal of the first difference generation circuit with a reference voltage Vref and generates a selection signal indicating the comparison result. Based on the selection signal, the selection circuit 35 selects either one of the output signal of the first difference generation circuit 32a and the output signal of the second difference generation circuit 32b as an image signal D1.

In the solid state imaging device formed as described above, the vertical scan circuit 13 (refer to FIG. 1A) varies the voltages of the drive signals S1 to S4 in response to a control signal from the control circuit 12 as shown in FIG. 5.

During the first reset period K1 from time t1 to time t2, the photoelectric conversion period K2 from time t2 to time t3, and the data read period K3 from time t3 to time t4, the pixels Ca operate in the same manner as in the first embodiment. During the data read period K3 from time t3 to time t4, the photoelectric conversion signal read from a pixel Ca is held by the first SH circuit 31a.

Next, in the second reset period K4, the voltage of the first drive signal S1 is first lowered to voltage V1a (=2[V]) and then raised to voltage V1c (=3.3[V]). Further, during the period in which the drive signal S1 has voltage V1a and the period during which the first drive signal S1 has voltage V1c, the signal line S3 is provided with the pulse-shaped third drive signal S3 having voltage V3b (=3.3[V]).

In the same manner as in the first embodiment, after the voltage of the first drive signal S1 rises from voltage V1a to voltage V1c, the third drive signal S3 causes a signal to be read from the pixel Ca. The signal read in this manner is held as a first reset signal by the second SH circuit 31b. Further, in the same manner as in the second embodiment, when the voltage of the first drive signal S1 is the voltage V1a, the third drive signal S3 causes a signal to be read from the pixel Ca. The signal read in this manner is held as a second reset signal by the third SH circuit 31c.

The first difference generation circuit 32a obtains the difference between the signal held by the first SH circuit 31a, or the photoelectric conversion signal, and the signal held by the second SH circuit 31b, or the first reset signal. The second difference generation circuit 32b obtains the difference between the signal held by the second SH circuit 31b, or the photoelectric conversion signal, and the signal held by the third SH circuit 31c, or the second reset signal.

The comparison circuit 34 compares the output signal of the first difference generation circuit 32a with the reference voltage Vref to generate a selection signal. In detail, the output signal of the first difference generation circuit 32a indicates the difference between the photoelectric conversion signal (potential at the sense node N1 generated during the photoelectric conversion period K2), which is read during the data read period K3, and the first reset signal, which is read during the second reset period K4 after the first drive signal S1 rises to the voltage V1c. Accordingly, the photoelectric conversion signal provided to the first difference generation circuit 32a is a signal obtained by performing logarithm conversion on the photocurrent Ip. In other words, the photoelectric conversion signal is a signal read from the pixel Ca when the intensity of the incident light is high. However, when the intensity of the incident light is low, the sense node N1 of the pixel Ca has a potential obtained by performing linear conversion on the photocurrent Ip as described in the second embodiment. For this reason, the above calculation result of the first difference generation circuit 32a cannot be used. Therefore, the comparison circuit 34 is employed to determine whether the photocurrent has undergone logarithm conversion or linear conversion.

In other words, the value of a photoelectric conversion signal that has undergone logarithm conversion differs from a photoelectric conversion signal that has undergone linear conversion. Thus, the reference voltage Vref is for determination of these signals. The reference voltage is determined from the current Ip_tr when the equation shown below is satisfied.

Vg−nkT/q×In(Ip_{—}tr/Ip0)=(Ip_{—}tr/Cp)×t_{—}a (12)

When the output signal of the first difference generation circuit 32a is greater than or equal to the reference voltage Vref, the photoelectric conversion signal is a signal that has undergone logarithm conversion. Accordingly, based on the comparison result of the comparison circuit 34, the selection circuit 35 selects the output signal of the first difference generation circuit 32a as the image signal D1.

When the output signal of the first difference generation circuit 32a is less than the reference voltage Vref, the photoelectric conversion signal is a signal that has undergone linear conversion. In this case, the threshold value Vt_1 of the first transistor T1 is further subtracted to obtain the output signal of the first difference generation circuit 32a. Accordingly, by adding the threshold voltage Vt_1 to the output signal of the first difference generation circuit 32a, the photoelectric conversion signal when performing linear conversion is obtained. That is, by calculating the difference between the value obtained from equation (11) and the value obtained from equation (4), Vt_1−(V2a−V1a) is obtained. In the term (V2a−V1a), V2a and V1a are preset known values. Thus, the term of (V2a−V1a) is obtained as a constant. Accordingly, the second difference generation circuit 32b obtains the threshold voltage Vt_1 of the first transistor T1 based on the second reset signal (valued obtained from equation (11)) held by the third SH circuit 31c, the first reset signal (valued obtained from equation (4)) held by the second SH circuit 31b, and the predetermined constant (V2a−V1a).

The adder circuit 33 adds the threshold voltage Vt_1 of the first transistor T1 obtained from the output signal of the second difference generation circuit 32b to the output signal of the first difference generation circuit 32a to generate a sum signal. The sum signal is a photoelectric conversion signal obtained by performing linear conversion on the photoelectric current Ip. The photoelectric conversion signal substantially does not include FPN. Based on the output signal of the comparison circuit 34, the output signal of the adder circuit 33 is selected as the image signal D1.

The third embodiment has the advantage described below.

The CDS circuit 16 of the third embodiment determines whether the photoelectric conversion signal read from the pixel Ca is a signal that has undergone logarithm conversion or a signal that has undergone linear conversion and outputs a signal calculated in accordance with the determination result. Accordingly, an image signal D1 from which FPN is eliminated is automatically generated in correspondence with a case in which the intensity of the incident light in the pixel Ca is high and a case in which the intensity of the incident light in the pixel Ca is low.

The above embodiments may be carried out in the forms described below.

In each of the above embodiments, the pixel Ca may be formed by a single photodiode PD and four P-channel MOS transistors.

In the third embodiment, the second difference generation circuit 32b may obtain the threshold voltage Vt_1 of the first transistor T1 (load transistor) from the difference between the first reset signal and the second reset signal. In this case, the adder circuit 33 adds the output signal of the second difference generation circuit 32b (threshold voltage Vt_1) to the output signal of the first difference generation circuit 32a.

1. A solid state imaging device comprising:
a pixel including:
a light reception element which performs photoelectric conversion on incident light;
a load transistor which receives a first drive signal and operates in response to a second drive signal;
a switch transistor connected between the load transistor and the light reception element, with a sense node being arranged between the load transistor and the switch transistor;
an amplification transistor having a control terminal connected to the sense node; and
a selection transistor connected to the amplification transistor;
a control means which drives the pixel during at least a photoelectric conversion period, a data read period, and a reset period, wherein the control means operates the load transistor in a subthreshold range in accordance with the first drive signal and the second drive signal during the photoelectric conversion period to perform photoelectric conversion on the incident light with the light reception element, activates the selection transistor during the data read period to read a potential at the sense node as a photoelectric conversion signal, and further operates the load transistor in the subthreshold range after deactivating the switch transistor and activating the load transistor during the reset period to activate the selection transistor when the load transistor is operating and read the potential at the sense node as a reset signal; and
a correlated double sampling circuit which obtains the photoelectric conversion signal and the reset signal to subtract the reset signal from the photoelectric conversion signal.

2. A solid state imaging device comprising:
a pixel including:
a light reception element which performs photoelectric conversion on incident light;
a load transistor which receives a first drive signal and operates in response to a second drive signal;
a switch transistor connected between the load transistor and the light reception element, with a sense node being arranged between the load transistor and the switch transistor;
an amplification transistor having a control terminal connected to the sense node; and
a selection transistor connected to the amplification transistor;
a control means which drives the pixel during at least a photoelectric conversion period, a data read period, and a reset period, wherein the control means operates the load transistor in a subthreshold range in accordance with the first drive signal and the second drive signal during the photoelectric conversion period to perform photoelectric conversion on the incident light with the light reception element, activates the selection transistor during the data read period to read a potential at the sense node as a photoelectric conversion signal, and further deactivates the switch transistor, activates the load transistor, and activates the selection transistor during the reset period to read the potential at the sense node as a reset signal; and
a correlated double sampling circuit which obtains the photoelectric conversion signal and the reset signal to subtract the reset signal from the photoelectric conversion signal.

3. A solid state imaging device comprising:
a pixel including:
a light reception element which performs photoelectric conversion on incident light;
a load transistor which receives a first drive signal and operates in response to a second drive signal;
a switch transistor connected between the load transistor and the light reception element, with a sense node being arranged between the load transistor and the switch transistor;
an amplification transistor having a control terminal connected to the sense node; and
a selection transistor connected to the amplification transistor;
a control means which drives the pixel during at least a photoelectric conversion period, a data read period, and a reset period, wherein the control means operates the load transistor in a subthreshold range in accordance with the first drive signal and the second drive signal during the photoelectric conversion period to perform photoelectric conversion on the incident light with the light reception element, activates the selection transistor during the data read period to read a potential at the sense node as a photoelectric conversion signal, and further operates the load transistor in the subthreshold range after deactivating the switch transistor and activating the load transistor during the reset period to activate the selection transistor when the load transistor is operating and read the potential at the sense node as a first reset signal and read the potential at the sense node when the load transistor is activated as a second reset signal; and
a correlated double sampling circuit which obtains the photoelectric conversion signal, the first reset signal, and the second reset signal to generate an image signal based on a first difference between the photoelectric conversion signal and the first reset signal and a second difference between the first reset signal and the second reset signal.

4. The solid state imaging device according to claim 3, wherein the correlated double sampling circuit includes:
a first sample hold circuit which holds the photoelectric conversion signal;
a second sample hold circuit which holds the first reset signal;
a third sample hold circuit which holds the second reset signal;
a first difference generation circuit which calculates the first difference between the photoelectric conversion signal held by the first sample hold circuit and the first reset signal held by the second sample hold circuit to generate a first output signal;
a second difference generation circuit which calculates the second difference between the first reset signal held by the second sample hold circuit and the second reset signal held by the third sample hold circuit to generate a second output signal;
an adder circuit which adds the first output signal of the first difference generation circuit and the second output signal of the second difference generation circuit to generate a sum signal;
a comparison circuit which compares the first output signal of the first difference generation circuit with a reference voltage to generate a selection signal; and
a selection circuit which selects as the image signal either one of the first output signal of the first difference generation circuit and the sum signal of the adder circuit based on the selection signal of the comparison circuit.
